(19) United States
(12) Patent Application Publication
(10) Pub. No.: US 2006/0231678 A1
(43) Pub. Date: Oct. 19, 2006

(54) High speed airship

(76) Inventor: Imre Nagy, San Diego, CA (US)

Correspondence Address: Imre Nagy, 6454 Cascade St., San Diego, CA, 92122, US

(21) Appl. No.: 10/565,179

(22) PCT Filed: Aug. 15, 2003
(86) PCT No.: PCT/US03/25458

§ 371 Date: Jan. 19, 2006

(51) Int. Cl. B64B 1/02

(52) U.S. Cl. 244/30

(57) ABSTRACT

A high speed airship (10) with multiple inflatable chambers (11) arranged in a multiplicity of tubular clusters to enhance structural strength and to create a centrally located passenger or cargo tunnel (18) to increase passenger safety. A conical shaped rigid frame front cabin (14) attached to the front end of the airship, and a conical shape rigid frame aft cabin (15) attached to the aft end of the airship, designed to reduce aerodynamic drag, to achieve high speed, and to be able to land on water. Specially designed multiple sections with multiple inner tubes to increase safety. Helium recovery system to control balance and buoyancy without the loss of helium and to eliminate the use of ballast, which otherwise would reduce lifting capacity. Independently rotateable propulsion units (22) for rapid balance and buoyancy control in emergency and to provide high maneuverability to eliminate the need of ground crew.

### BACKGROUND OF THE INVENTION

Most of airships are designed with a rigid frame structure that carries all the load. The drawback of the rigid frame is that it can be damaged easily, especially during hard landing, not to mention the costs and weight of the rigid frame. The passenger cabin is attached under the belly of the airship.

The blimp on the other hand has no rigid frame, the inflated envelop cares all the load. The passenger cabin is attached under the belly of the blimp.

Each of these designs can lead to poor performance or even disasters.

By analyzing airship disasters it becomes clear that:

#1 cause: Lack of rapid buoyancy control.—The primary buoyancy of the airship is controlled by the volume of the helium, that is too slow to enable significant changes in an emergency, such as those caused by interception with violent storm or turbulent air.—The secondary buoyancy control is by using ballast, the most common ballast used is water, but in frizzing temperature it becomes ice it can lead to disaster. Not to mention the waste of lifting power caused by the need of ballast.

#2 cause: Lack of flight control during landing and take off. If there is no air speed, there is no rudder or elevator compensation, the airship is at the mercy of the wind.

#3 cause: Placing the passenger and crew cabin under the airship. In case of an emergency the airship crashes on the cabin and the ground crew, damaging the control mechanism, injuring or killing the crew and passengers, or if it happens over water the cabin sink below the water, the crew and the passengers may ground and the airship goes out of control.

#4 cause: The use of explosive hydrogen as a lifting gas.—By using helium eliminates fire or explosion hazard.

My study resulted in a design that addresses all of these problems producing a safe, reliable and high speed airship.

### SUMMARY OF THE INVENTION

Multiple inflatable chambers are arranged in a multiple tubular cluster to structurally support each other, and to create a centrally located protected tunnel in the center of the airship, where passengers or cargo can be placed. A highly aerodynamic conical shaped rigid frame cabin which incorporates the cockpit and passenger lift is attached to the front end of the airship, and a rigid frame aft cabin incorporate the cargo lift is attached to the aft end of the airship. This design reduces aerodynamic drag, vastly increases passenger safety and makes it possible to land on water, solving the #3 cause of airship disaster.

The multiple inflatable chambers divided into a multiple inflatable sections, wherein each section has a multiple inner tube. One inner tube is reserved to contain helium, another inner tube is reserved to contain air. This means that any of the chambers or any of the sections can be inflated with air or helium, or any percentage of air or helium without mixing the helium with air. The excess helium is pumped back, and stored in an onboard container until further use, this helium recovery system creates the needed precise control of the balance and buoyancy, and absolutely eliminates the use of ballast weight.

Multiple rotateable propulsion units attached to both sides of the airship, can be independently rotated into any position of a 360 degree circle. The propeller thrust assures absolute and rapid control over speed, direction, balance and buoyancy, solving the #1 and #2 cause of airship disasters and eliminating the need for a ground crew.

### BRIEF DESCRIPTION OF THE DRAWINGS

FIG. 1. Side view of the airship according to the present invention.

FIG. 2. View of perpendicular cross-section of the airship according to the present invention.

FIG. 3. View of longitudinal cross-section of the airship according to the present invention.

### DESCRIPTION OF THE PREFERRED EMBODIMENT

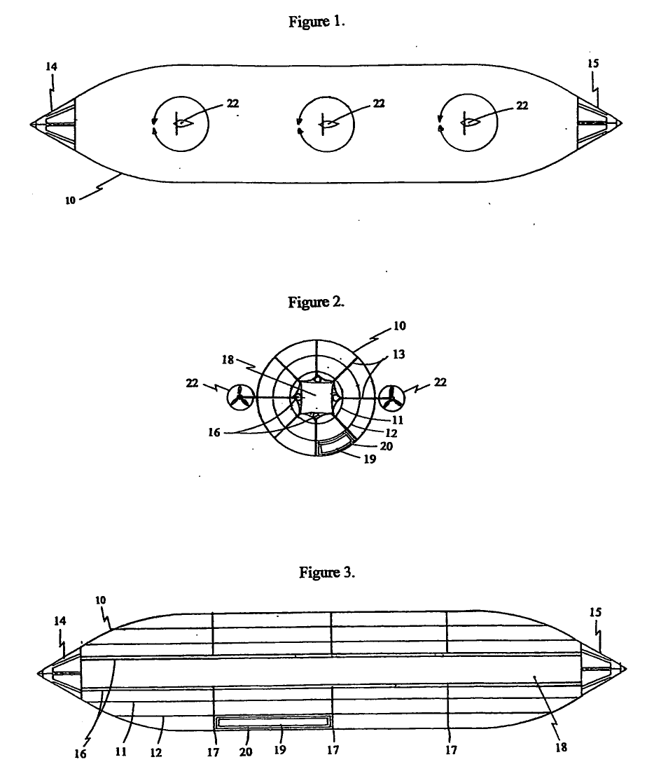

Referring to FIG. 1, the airship according to the invention comprises:

Envelope 10, adapted to contain helium or air.

Passenger or cargo tunnel 18, in the longitudinal center of the envelop 10.

Rigid frame cabin 14, attached to the front end of the envelop 10.

Rigid frame aft cabin 15, attached to the aft end of the envelop 10.

In the preferred embodiment, the airship has six propulsion units 22, three propulsion unit on each side of the envelop 10, each propulsion unit contains engine, propeller and is attached to the envelop with a pivoting shaft so each of the propellers plane of rotation can be independently rotated into any direction of the 360 degree circle.

Referring to FIG. 2, and FIG. 3, envelop 10, all-fabric structure has:

Multiple longitudinal dividers 13, are perpendicular to the longitudinal center line of the airship.

Multiple tubular dividers 11, and 12, which center line same as the airship longitudinal center line but having different radius.

Multiple cross dividers 17, to divide the longitudinal chambers to multiple sections, each section contains multiple inner tubes, an inner tube 19, is reserved for helium, an inner tube 20, is reserved for air, each inner tube have inflating port, valve, piping to the pump and to the helium containers 16. Each inner tube can be inflated or deflated selectively to control the helium/air ratio and therefore control balance and buoyancy.

I claim as my invention is:

1. High speed airship, comprising:
a. Longitudinal multiple inflatable chambers arranged in a multiple tubular cluster to support each other and to create a centrally located tunnel for passenger or cargo space.
b. A conical shaped rigid flame cabin attached to the front and aft end of the passenger or cargo tunnel.
c. Multiple propulsion units, attached to both sides of the airship with a pivoting mechanism, configured such way that the propellers plane of rotation is perpendicular to the center line of the airship, and each propulsion unit is can be independently rotated into any position of the 360 degree circle.

2. The high speed airship of claim 1, wherein said longitudinal multiple inflatable chambers arranged in multiple tubular cluster are divided into multiple longitudinal sections.

3. The high speed airship of claim 2, wherein said multiple longitudinal independent inflatable chambers are divided into multiple longitudinal sections, all the sections of having multiple inner tubes, one inner tube reserved to contain helium while other inner tube is reserved to contain air.

4. The high speed airship of claim 1, wherein said a conical shaped rigid frame front end cabin is contains the cockpit and the passenger elevator.

5. The high speed airship of claim 1, wherein said a conical shaped rigid frame aft end cabin is contains a cargo elevator.

6. The high speed airship of claim 1, further comprising a pumping mechanism and containers to recover the helium from the inner tubes reserved for helium, and pumped back to the container where it can be stored and used again when it needed.

7. The high speed airship of claim 1, further comprising external cargo anchoring attachments.
